(19) United States
(12) Patent Application Publication
(10) Pub. No.: US 2004/0260912 A1
(43) Pub. Date: Dec. 23, 2004

(54) Arrangement and a method in processor technology

(76) Inventor: Nils Ola Linnermark, Johanneshov (SE)

Correspondence Address: ERICSSON INC., 6300 LEGACY DRIVE, M/S EVR C11, PLANO, TX, 75024, US

(21) Appl. No.: 10/493,185

(22) PCT Filed: Oct. 24, 2001
(86) PCT No.: PCT/SE01/02325

(51) Int. Cl. G06F 9/30

(52) U.S. Cl. 712/218

(57) ABSTRACT

A processor (PR2) has a functional unit (FU21) connected to series coupled temporary registers (TR21-TR23) and to a register file (RF2), which has an output connected to an input (IP1) of the functional unit via multiplexors (MUX1-MUX4). Read addresses (B, E, A) and write addresses (A, D, G) are sent to the register file and to a control means. The latter includes registers (REG1-REG4) and comparators (C1-C4) which control the multiplexors (MUX1-MUX4). On a read address (B) a value (V(B)) is sent to the functional unit (FU21) after the register file access time has lapsed. The functional unit performs an operation and the result (V(A)) is clocked through the temporary registers (TR1-TR3) and is sent to the register file (RF2). A later read address (A) coincides in the comparator (C2) with a write address (A) from the register (REG2), the multiplexer (MUX2) is switched and the result (V(A)) is fetched from the temporary register (TR1). The result (V(A)) can already be used, although it is under access in the register file (RF2) and can not yet be fetched from there.

### TECHNICAL FIELD OF THE INVENTION

The present invention is related to an arrangement and a method in multiple-issue processor technology and more closely to an arrangement and a method to get a rapid and flexible multiple-issue processor.

### DESCRIPTION OF RELATED ART

In processor design it is a desire to bring about a fast and flexible processor. In the processors, computation is performed in some type of device for computation and the results are stored in a register file. The results are fetched from the register file to be used in a subsequent computation of new results, which in turn can be stored in the register file. The process is controlled by a program in a program store. To make the processor more flexible and faster, reading and writing is performed for many computation devices simultaneously and independently of each other. A problem here is slow memories, e.g. the slow register file.

Multiple-issue processors allow multiple instructions to issue in a clock cycle. Commonly multiple-issue processors are divided up into two types, superscalar processors and VLIW (very long instruction word) processors. Superscalar processors issue varying numbers of instructions per clock cycle and can be either statically or dynamically scheduled, while VLIW processors issue a fixed number of instructions per clock.

The processor works at a certain clock frequency. As a general rule the performance increases with increasing clock frequency but there are also drawbacks to have a high clock frequency. One such drawback is that the pipeline length increases. Increasing pipeline length means that unpredictable or wrongly predicted jumps in the processor causes increasing delay, which means that the execution time increases. Another drawback is that high clock frequency design is generally difficult to implement. The clock distribution has to be done in such a way that minimal clock skew is inferred. To counteract this problem it is proposed to divide the design in different clock regions with substantial mutual clock skew, which affects the processor design.

Another factor that affects the processing speed is the propagation delay, which is made up of interconnect delays and gate delays. The interconnect delay is a continuously increasing part of the delay for each new technology generation. This means that the memory access will be more critical, since memory access time to large extent is interconnect delay.

The processing speed is affected by the memory design itself. Full custom design is performed on transistor level, the location of every transitor on a chip is optimized. There are many possibilities to optimize the processor design, and especially the memory design, for short delays. Making full custom design is anyhow costly and is not usable for small-size projects. An alternative to full custom design is cell library design, in which precompiled standard memories from a manufacturer are used. The cell libraries are placed on a chip in accordance with a specification from a customer. This design will give longer delays than full custom design but is cheaper. Still an alternative is gate array design, in which the standard cells are placed in a standard pattern on a chip by the manufacturer. Only the connection pattern can be designed by the customer. This design will give still longer delays.

Also another factor in the memory design affects the access delay. In both VLIW (very long instrucion word) and suoerscalar processor design multiported memories are used for the register file. The number of functional units can be high and every unit implies two read and one write port on the memory. The total number of ports is consequently high which will increase the access delay.

Renaming of register in the register file is a method used in out-of-order processors, that is processors that unlike VLIW processors execute the instructions in an order different from the instruction order in the code. In those processors the register data that is read at the operand-fetch stage is not always the correct data, since instructions not yet executed or speculatively executed can alter the register data. One method of implementing renaming is to store results from ALU (arithmetic logic unit) operations in temporary registers in the register file.

The U.S. Pat. No. 6,128,721 discloses a processor having an execution pipeline, a register file and a controller. The register file includes primary registers and temporary registers. It is mentioned that there are several problems with the introduction of temporary registers into the pipelines. In the patent the execution pipeline has a first stage for generating a first result and a second stage for generating a final result. The results are stored in the register file and the first result is made available if it is needed for an execution of a subsequent instruction. The lengt of the execution pipeline is reduced. The memory design for the register file and its access time is not discussed.

The international patent application with publication number WO 00/54144 discloses register file indexing in a VLIW processor to allow efficient implementation without the use of specialized vector processing hardware.

The U.S. Pat. No. 5,644,780 discloses a high speed register file for a VLIW or a superscalar processor.

### SUMMARY OF THE INVENTION

The present invention is concerned with the main problem to get a rapid and flexible pipelined processor.

A further problem is to facilitate the use of a high processor clock frequency.

Another problem is to operate different processor computation devices independently of each other.

Still a problem is to facilitate the use of standard units in the processor design and manufacture and particularly, in an embodiment, using standard cell libraries including standard memories.

The problem is solved by storing computational results from the computation device in temporary registers, which are connected to respective of the computation device. The results are immediately available and can be utilized when required.

More closely the problem is solved by storing the computational result from a computation device in a set of temporary registers. The storing includes that the result is consecutively clocked through the set of registers and the result can be utilized when required. New results can be stored in this way one after the other. A time interval for the storing process can be selected by selecting the number of temporary registers. In an embodiment the time interval corresponds to the access time for a permanent memory device, i.e. it lasts until the computational result is stored in the permanent memory device, from which it then can be fetched when required.

A purpose with the invention is to get a rapid and flexible processor.

A further purpose is to derive advantage from high clock frequency in the processor.

Another purpose is to facilitate that different computation devices are operated independently of each other.

Still a purpose is to facilitate the use of standard units in the processor and particularly, in an embodiment, use of standard cell libraies including standard memory devices.

An advantage with the invention is that a processor with the temporary registers will be rapid and flexible.

A further advantage is that a high clock frequency can be fully utilized.

Another advantage is that different computation devices can be operated independently of each other.

Still an advantage is that standard units can be used in the processor, e.g. standard cell libraries including standard memories for a register file.

The invention will now be more closely described by prefered embodiments in connection with the enclosed drawings.

### BRIEF DESCRIPTION OF THE DRAWINGS

FIG. 1 shows a block diagram with an overview over a VLIW processor;

FIGS. 2a and 2b show block diagrams over alternative embodiments of parts of the processor;

FIG. 3 shows a pipeline diagram for a processor;

FIG. 4 is a block diagram showing more in detail logic circuits for the processor in FIG. 1;

FIG. 5 is a block diagram over alternative logic circuits;

FIG. 6 is a block diagram over still alternative logic circuits;

FIG. 7 shows a block diagram with circuits for a superscalar processor; and

FIG. 8 is a flow chart over a method in the processors in FIGS. 1-6.

### DETAILED DESCRIPTION OF EMBODIMENTS

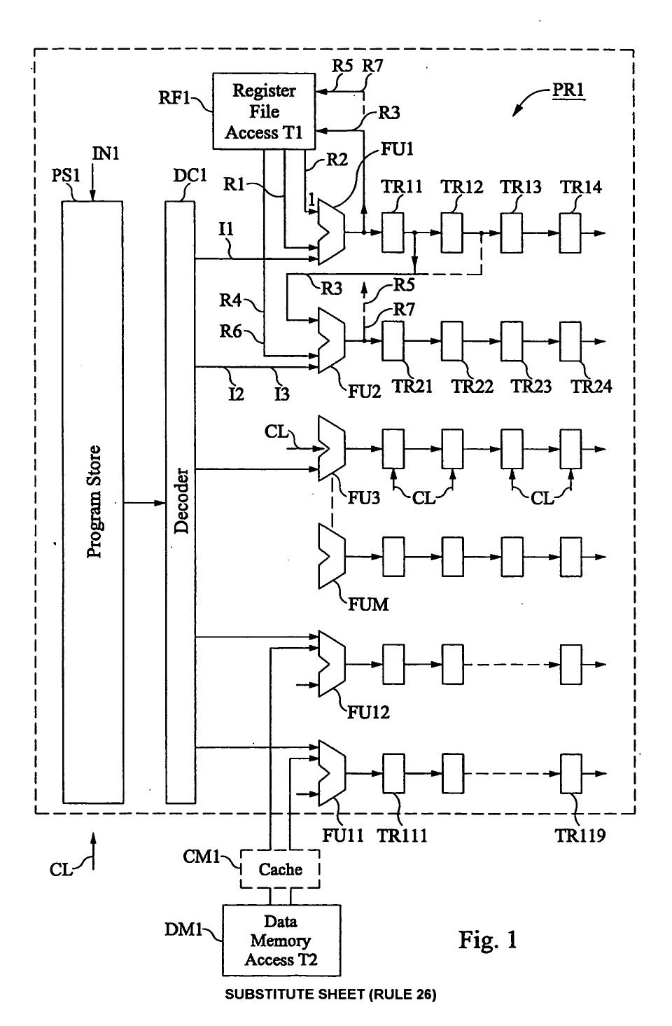

FIG. 1 is a block diagram showing an overview over a multiple-issue processor PR1. The processor has a program store PS1 with an input IN1 and with an output which is connected to a decoder DC1. It also has a first memory device in form of a register file RF1 for storing computational results and a second memory device in form of a data memory DM1. In an alternative a cache memory CM1 is connected to the data memory, as indicated by dotted lines. A first set of computation devices in form of functional units FU1, FU2, . . . FUM have inputs which are connected to the decoder and to outputs of the register file. Each of these functional units has an output, which is connected to a temporary register device in form of a pipeline tail of series coupled temporary registers. The functional unit FU1 is thus connected to the series coupled temporary registers TR11, TR12, TR13 and TR14, unit FU2 is coupled to temporary registers TR21, TR22, TR23 and TR24 and so on for the first set of functional units. A second set of functional units FU11 and FU12 have inputs which are connected to the decoder and to the data memory DM1. The functional units in the second set also have each a pipeline tail. The latter is rather long as the access time T2 for the data memory DM1 is rather long. In the figure is indicated that the functional unit FU11 has a pipeline tail of nine temporary registers TR111 to TR119. The processor PR1 works synchronously in wellknown manner and is controlled by clock pulses CL, which are indicated at some locations in the figure. The clock pulses are spread by a separate network, not shown in the figure.

The exemplified processor PR1 is a VLIW (very long instruction word) processor that works at a certain clock frequency, controlled by the clock pulses CL. The register file RF1 is of the previously mentioned type cell library and is rather slow with an access time T1. In the embodiment in FIG. 1 it takes five clock periods from the moment a value was received by the register file RF1 until the value has been stored and can be fetched. This delay is also the reason why there are four temporary registers in the pipeline tail, as will appear from the description below.

The functional units FU1, FU2, . . . FUM in the first set perform arithmetical and logical operations, e.g. the operation

R3=R1+R2 (1)

This operation is performed by the processor PR1 in the following manner. On an instruction I1 from the program store PS1 the functional unit FU1 fetches the values R1 and R2 from the register file RF1. The addition is performed and the result, the value R3, is sent to the register file RF1 to be stored there. The value R3 is also sent to the temporary register TR11 and is immediately stored there. All the operation is performed during a first clock period.

In a second clock period, directly following on the first, the program store PS1 sends an instruction I2 to the functional unit FU2 to perform an operation

R5=R3+R4 (2)

The functional unit FU2 fetches the value R4 from the register file RF1 and fetches the value R3 from the temporary register TR11. Note that the value R3 can not yet be fetched from the register file RF1, because its access time is so long and the value R3 is not yet stored there. The addition is performed and the result, the value R5, is sent to the register file RF1 to be stored and is also immediately stored in the temporary register TR21. The value R3 is clocked into the next termporary register TR12 in the pipeline tail during the second clock period. A new operation can be performed in the functional unit FU1 during the second clock period and a result is immediately stored in the temporary register TR11.

In a third clock period the program store PS1 sends an instruction I3 to the functional unit FU2 to perform the operation

R7=R6+R3 (3)

The value R6 is fetched from the register file RF1, the value R3 is fetched from the temporary register TR12, the addition is performed and the result, the value R7, is sent to the register file. It is also immediately stored in the temporary register TR 21. The earlier value R5 in the temporary register TR21 is clocked into the register TR22 and the earlier value R3 in the temporary register TR12 is clocked into the temporary register TR13.

In this manner the calculated values are successively clocked through the pipeline tails and can be fetched there until the pipeline tail ends. The value R3 for example can be fetched in a consecutive fifth clock period from the temporary register TR14. In a next clock period, a sixth period, it can be fetched from the register file RF1, because the value R3 is then stored there and can be fetced from there as rapidly as from one of the temporary registers.

The functional units FU11 and FU12 work together with their temporary registers and the data memory DM1 in the same way as decribed above for the functional units FU1-FUM.

The processor is flexible in that the different functional units can fetch values from each other's temporary registers independently of each other. It is rapid in that a value calculated in one clock period can be used for computation already in the next clock period although the value is still under access in the register file. It is possible and efficient to use a high clock frequency although the register file can still be slow. A higher clock frequency results in that the access time lasts for more clock periods. Using a sufficiently long pipeline tail it is possible to use a calculated value immediately and during all the register file access time.

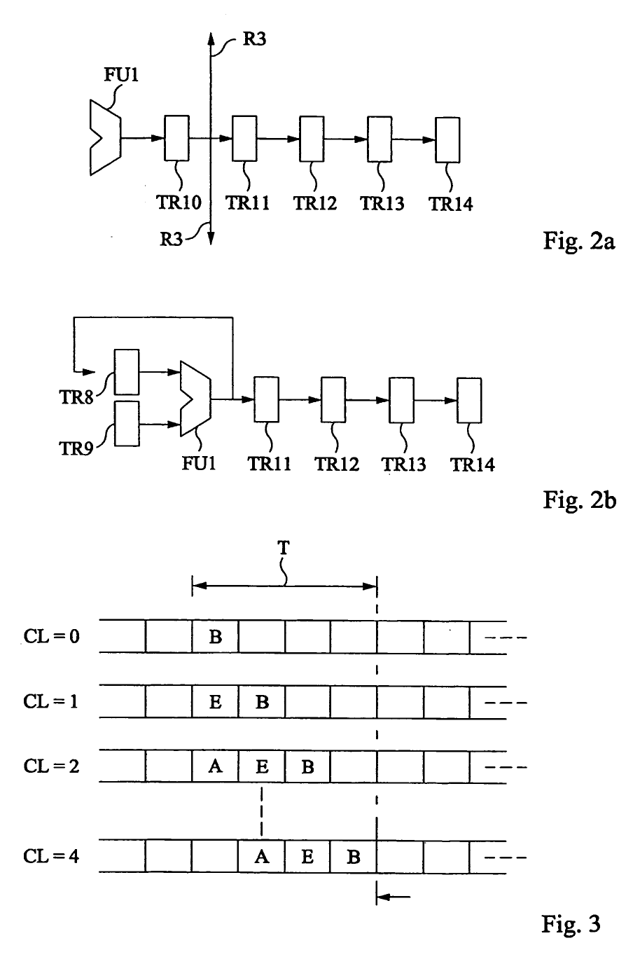

In FIG. 2a is shown an alternative to the pipeline tail for the functional unit FU1 in FIG. 1. The pipline tail having the temporary registers TR11, TR12 . . . begins with a register TR10 in which a calculated value is always stored, also before it is sent to the register file RF1. In FIG. 2b is shown still an alternative with registers TR8 and TR9 at the inputs to the functional unit FU1.

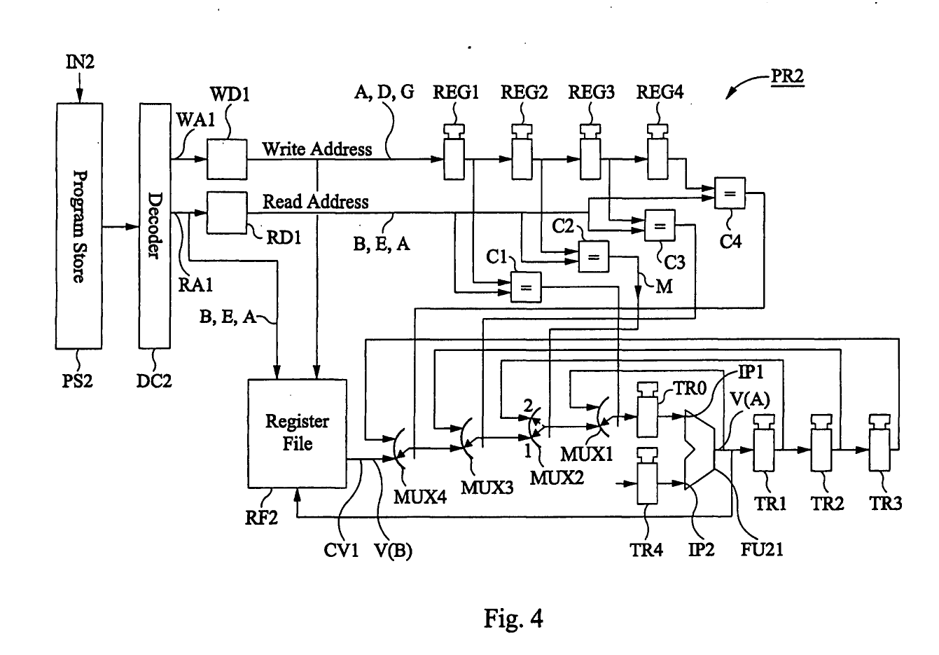

In connection with FIG. 3 and FIG. 4 it will be more closely described how the functional unit with its pipeline tail is designed and how it works. The function will be descibed in connection with the following three calculations successively performed in one of the functional units:

A=B+C

D=E+F (4)

G=A+H

The letters A to H all denote adresses in different registers and corresponding values on these adresses will be denoted V(A), V(B) and so on in the description below.

FIG. 3 shows pipeline diagrams, which together is an overview over how different jobs are pipelined in the processor. As an example it is shown how the above adresses B,E and A are clocked forward in the register file, having an access time of four clock periods. At a moment denoted by the clock CL=0 the address B is clocked into the register file. The register file will read the address B during the access time, denoted T1 in the figure. At next clock period CL=1 the address B is stepped forward and the next address E is clocked in. At clock period CL=2 the address A is clocked in. At a clock period CL=4 the address B is accessed and the value V(B) on the address B can be fetched from the register file.

FIG. 4 shows a part of a single-issue processor PR2 having a functional unit FU21 with a pipeline tail of temporary registers TR1, TR2 and TR3 connected to its output. At one of its inputs IP1 the functional unit is connected to a temporary register TR0 and at the other input IP2 it is connected to a temporary register TR4. The processor has a program store PS2 which is connected to a decoder DC2. The decoder has two outputs, one write address otput WA1 and one read address output RA1. The write address output is connected to a first delay circuit WD1 including a number of registers and the read address output is connected to a second delay circuit RD1 also including a number of registers. The read address output RA1 is connected to a register file RF2, which has a certain access time of four clock periods and the delay circuits WD1 and RD1 have the same delay time, four clock periods. The first delay circuit WD1 is connected to the register file RF2 and to a set of series coupled registers REG1 to REG4. The second delay circuit RD1 is parallelly connected to a respective first input on a set of comparators C1 to C4. The comparators have each a second input which is connected to a respective one of the registers REG1 to REG4. The register file RF2 has an output CV1 which is connected to the the temporary register TR0 via a set of series coupled multiplexors MUX1 to MUX4. The multiplexors are connected to each other via each a first input and have each a second input which is connected to a respective one of the outputs from the functional unit FU21 and the temporary registers TR1, TR2 and TR3. The multiplexors have each a control input which is connected to an output on a respective one of the comparators C1 to C4. The output of the functional unit FU21 is connected to an input on the register file RF2.

In FIG. 4 the write addresses A, D and G and the read addresses B, E and A of the formula (4) are denoted.

The functional unit FU21 has a second input IP2 which is connected to a logic cicuitry which is of the same design as the above described logic, connected to the first input IP1. This logic circuitry is not shown, not to make the figure too complicated.

The function of the register pipeline tail TR1, TR2 and TR3 will be described below in connection with the processor PR2 in FIG. 4 and the formula (4). Some essential of the events during processing of the formula (4) will be denoted in Table 1 below to give an overview of the processing.

TABLE 1

| CL1 | CL2 | CL3 | CL4 |
|---|---|---|---|
| A: REG1 | D: REG1 | G: REG1 | |
| | A: REG2, C1 | D: REG2, C1 | |
| | | A: REG3, C2 | |
| B: C1-C4 | E: C1-C4 | A: C1-C4 | |
| | | MUX2 switched | |
| V(B): TR0 | V(A) = V(B) + V(C): | V(A): TR2, TR0 | V(G) = V(A) + V(H): |
| V(C): TR4 | TR1, RF2 | V(A): RF2 | TR1, RF2 |
| | | V(H): TR4 | V(A): RF2 |

In the table head four consecutive clock periods CL1-CL4 are given. For each clock period is then noted what happens in the registers REG1-REG4, after that what happens in the comparators C1-C4, then what happens whith the multiplexors and at last the calculations in the functional unit FU21 and the storing in the temporary registers TR0-TR3 and the register file RF2.

The processing of formula (4) begins with that the write addresses A, D and G are successively clocked from the decoder DC2 into the first delay circuit WD1. The read addresses B, E and A are successively clocked into the second delay circuit RD1 and these addresses are also successively clocked into the register file RF2. The read addresses C, F and H are clocked from the decoder, which is not shown in FIG. 4 or in table 1.

At a moment denoted as clock period CL1 the write address A is written into the register REG1, see upper left in the table. In the same clock period CL1 the read address B is sent to all the comparators C1-C4 and the value V(B) is sent from the register file RF2 and is stored in the register TR0. All these events take place during the clock period CL1 because the delay time of the delay circuits WD1 and RD1 are the same and correspond to the access time for the register file RF2. The value V(C) is written into the register TR4 but, as mentioned above, the cicuits for this writing are not shown in FIG. 4.

In the next clock period CL2 the write address D is written into the register REG1 and the write address A is written into the register REG2 and is sent to the comparator C1. The read address E is sent to all the comparators C1-C4. In the functional unit FU21 the value V(A)=V(B)+V(C) is calculated and the value V(A) is stored in the register TR1. The value V(A) is also sent to the register file RF2 to be stored there, which storing takes all the access time for the register file.

In the following clock period CL3 the write adress G is written into the register REG1, the write address D is written into the register REG2 and is sent to the comparator C1 and the write address A is written into the register REG3 and is sent to all the comparators C1-C4. The comparator C2 now has the address A on both its inputs and givs an output signal M to the multiplexor MUX2. This multiplexor switches from a position 1 to a position 2. The value V(A) is written into the temporary register TR2 and is also written into the temporary register TR0 via the multiplexor MUX2. The value V(A) is also under storing in the register file RF2. In the same way as described, the value V(H) is written into the temporary register TR4.

Finally, in the clock period CL4, the value V(G)=V(A(+V(H) is calculated in the functional unit FU21 and is written into the temporary register TR1 and is also sent to the register file RF2 to be stored there. The value V(A), that was sent to the register file RF2 during the clock period CL2 is still under storing there.

In the description above, for simplicity, not all the events that take place during the processing of the formula (4) are mentioned. For example the write addresses G, A and D are stepped forward to the register REG4 and the value V(E) is calculated. The essential thing that appears is that the value V(A), calculated in the clock period CL2, can be utilized for calculation already in the clock period CL4, although it is still under storing in the register file RF2. In fact the value V(A) could have been utilized already in the clock period CL3, if required.

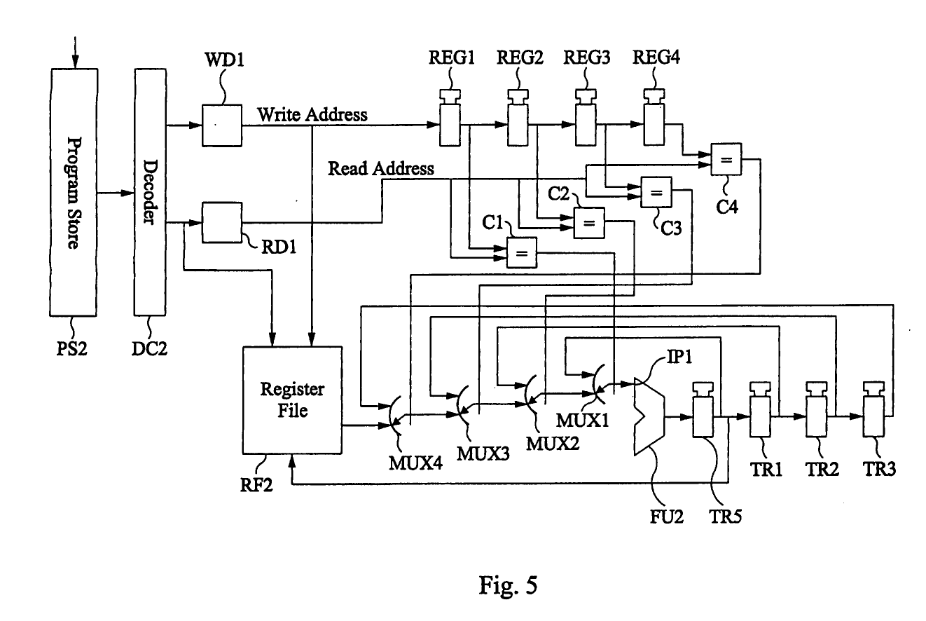

FIG. 5 shows an alternative embodiment to the processor PR2 in FIG. 4. The processor in FIG. 5 has the program store PS2, the decoder DC2, the delay circuits WD1 and RD1, the registers REG1-REG4 and the comparators C1-C4. It also has the the register file RF2, the multiplexors MUX1-MUX4 and the temporary registers TR1-TR3. The difference is that the functional unit FU2 lacks the registers TR0 and TR4 at its inputs IP1 and IP2 but instead has a temporary register TR5 at its output. Values calculated in the functional unit FU2 are always stored in this register TR5 before they are stored in the register file RF2 or eventually returned to the input IP1.

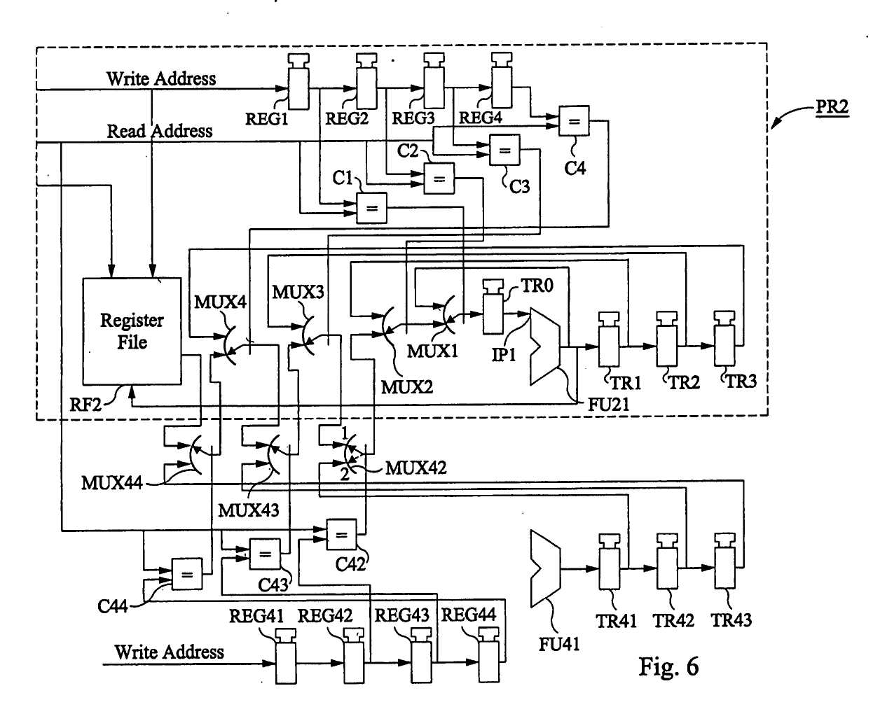

FIG. 6 shows still an alternative embodiment. In the figure the processor PR2 from FIG. 4 is shown within dotted lines. The processor PR2 is completed with a parallell functional unit FU41 having a pipeline tail of temporary registers TR41, TR42 and TR43. The embodiment in FIG. 6 is thus a multiple-issue processor. The pipeline tail TR41-TR43 is connected to locic circuit, in which a write address comes to a set of pipelined registers REG41, RFG42, REG43 and REG44, which are connected to a set of comparators C42, C43 and C44. The comparators are connected to a set of multiplexors MUX42, MUX43 and MUX44. As appears from the figure this parallell pipeline tail with its locic circuit is of the same design as corresponding elements in the processor PR2 and it also functions in the same manner. A dependency check in the processor PR2 can be done against all instructions corresponding to data in the parallell pipeline tail. In the embodiment it is assumed that the result from the functional unit FU41 will not be available in the functional unit FU21 until one clock period has passed to avoid a transportation delay that is added to the functional unit delay. The parallell functional unit FU41 with its pipeline tail of temporary registers TR41-TR43 and logical circuitry functions in the same way as the processor PR2. At a coincidence of the write and read addresses in e.g. the comparator C42 the multiplexor MUX42 is switched from a position 1 to a position 2. A value is then fetched from the temporary register TR41 and is transported to the temporary register TR0 at the input IP1 of the functional unit FU21.

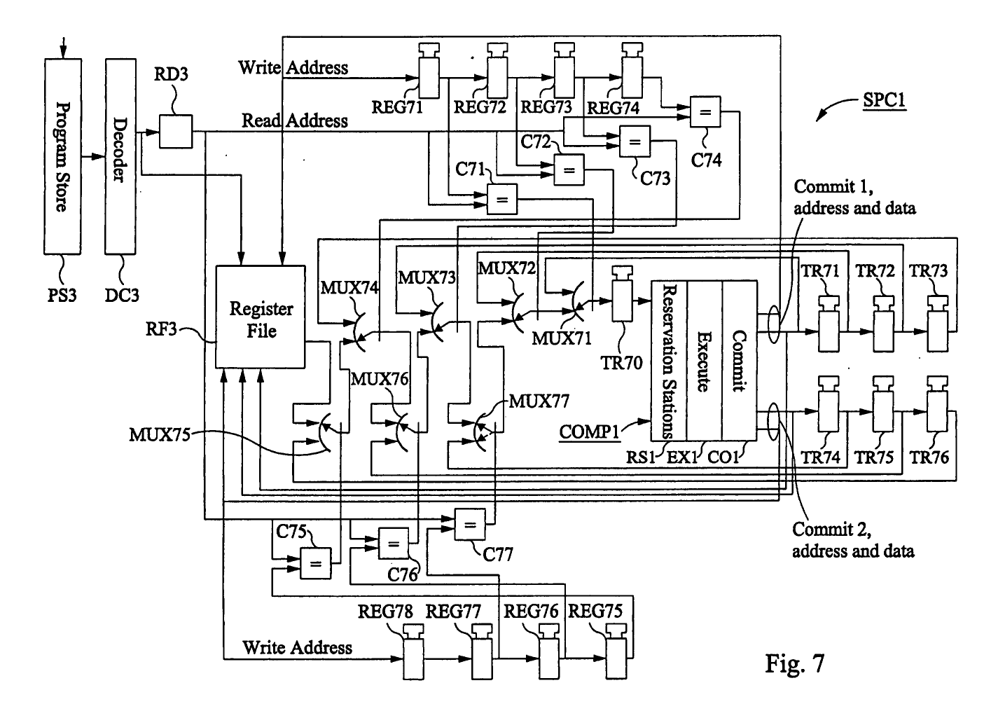

FIG. 7 shows a superscalar processor SCP1. Like the previously described processors it has a program store PS3 connected to a decoder DC3. The decoder is connected to a register file RF3 and to a delay circuit RD3, which is connected to a first set of comparators C71-C74 and to a second set of comparators C75-C77. The register file output is connected to a first set of multiplexors MUX71-MUX74 and to a second set of multiplexors MUX75-MUX77, which are connected to a computational unit COMP1 via a temporary register TR70. A first pipeline tail of temporary registers TR71-TR73 is connected to a first output of the computational unit and a second pipeline tail of temporary registers TR74-TR76 is connected to a second output of the computational unit COMP1. Outputs from the temporary registers are connected to the multiplexors, which are controlled by the comparators. The computational unit comprises a reservation stations block RS1, an execution block EX1 and a commit block CO1. A first address output from the commit block is connected to a first set of registers REG71-REG74 and to the register file RF3. A second address output from the commit block is connected to a second set of registers REG75-REG78 and to the register file RF3. Each of the comparators C71-C77 is connected to its respective one of the registers REG71-REG78. The reservation station RS1 fetches and buffers an operand as soon as it is available and when successive writes to a register appear, only the last one is used to update the register. When all operands actual for an instruction are available in the reservation station, the execution block EX1 executes the instruction. In the commit block then commit is made on the already executed instructions in a consecutive order, i.e. in the order they are read from the program store.

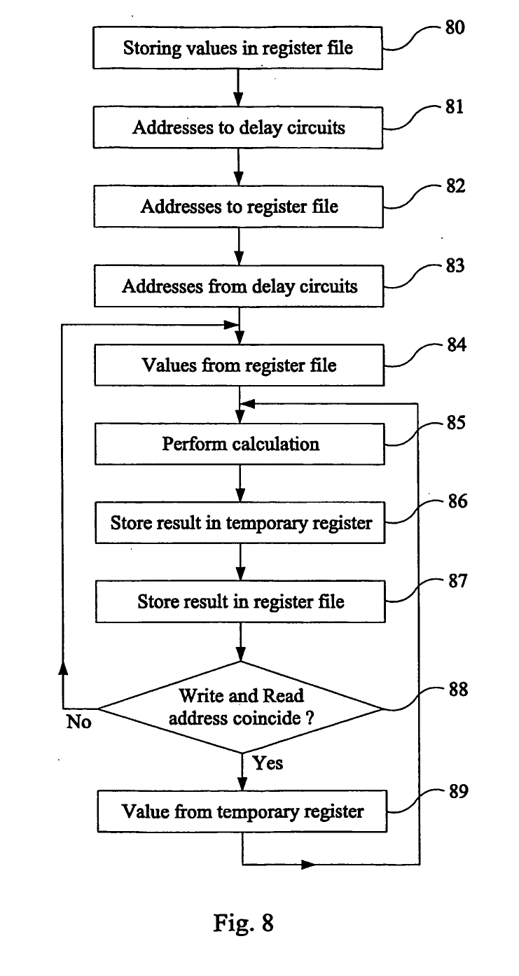

FIG. 8 shows a flow chart for an overwiev over a method in connection with the above described processors. The method is also described in connection with the above Table 1. The method starts in a method step 80, in which values are stored in the memory device. In a next step 81 the write and read addresses are sent to the respective delay units, WD1 and RD1 or WD3 and RD3. The read addresses are also sent to the register file, RF1 or RF3, according to a step 83. The addresses are executed in the register file and when its access time is out the value on the read address is sent from the register file and the read and write addresses are sent from the delay units, see step 84. In a next step 85 calculations are performed in the functional unit FU21 or in the computational unit COMP1. The result of the calculations is stored in the first temporary register and is then successively clocked forward to the following temporary registers, see step 86. The storing in the register file begins according to a step 87. As the read and write addresses are clocked forward a coincidence of these addresses can occur in one of the comparison units, C1-C4 or C71-C74, according to a step 88. If this coincidence does not occure according to an alternative NO, new values are fetched from the register file in the step 84. When coincidence occure according to an alternative YES, a corresponding one of the multiplexors is switched. According to a step 89 a value from one of the temporary registers is fetched and is utilized in a calculation according to the step 85.

1-17. (Cancelled)

18. A pipelined processor, comprising:
a memory device for storing values and having an access time;
at least one computational device being connectable to the memory device and generating computational results that are stored in the memory device;
a temporary register device connected to the computational device and storing said computational results during at least a part of the access time for the memory device; and
a control means connected to the temporary register device, the control means being arranged to fetch the computational results from the temporary register device for use in further computations.

19. A pipelined processor, comprising:
a memory device for storing values on addresses and having an access time;
at least one computational device for generating computational results in connection with address instructions, the computational device being connectable to the memory device;
a temporary register device connected to an output of the computational device, the temporary register device storing said computational results during at least a part of the access time for the memory device; and
a control means connected to the temporary register device, the control means being arranged to fetch the computational results from the temporary register device on receiving corresponding address instructions, the results being intended for use in further computations.

20. The processor according to claim 19, wherein the control means is adapted, when fetching said computational results, to compare a read address with a write address and, on coincidence of the addresses, to fetch the corresponding computational result from the temporary register device.

21. The processor according to claim 18, wherein the computational results are used in further computations during the memory device access time.

22. The processor according to claim 18, wherein the temporary register device includes a pipeline tail of series coupled temporary registers.

23. The processor of claim 22, wherein said pipeline tail includes at least three temporary registers.

24. The processor according to claim 18, wherein the memory device is a register file.

25. The processor according to claim 18, wherein the memory device is a first level data cache memory.

26. The processor according to claim 18, wherein the processor is a multiple-issue processor.

27. The processor according to claim 18, wherein the processor is a single-issue processor.

28. The processor according to claim 18, wherein the processor is a VLIW processor.

29. The processor according to claim 18, wherein the processor is a superscalar processor.

30. A method in a pipelined processor, said processor including a memory device and at least one computational device, said method comprising the steps of:
storing values in the memory device, the memory device having an access time; generating computational results in the computational device;
storing said computational results in a temporary register device during at least a part of the access time for the memory device;
controlling the temporary register device by a control means; and
fetching the computational results from the temporary register device by the control means for use in further computations.

31. A method in a pipelined processor, said processor including a memory device and at least one computational device, said method comprising the steps of:
storing values on addresses in the memory device, the memory device having an access time;
generating computational results in the computational device in connection with address instructions;
storing said computational results in a temporary register device during at least a part of the access time for the memory device;
controlling the temporary register device by a control means; and
fetching the computational results from the temporary register device by the control means for use in further computations.

32. The method according to claim 31, further comprising the steps of:
comparing in the control means a read address and a write address;
noting a coincidence of the addresses; and
fetching the corresponding computational result from the temporary register device for further computations.

33. The method recited in claim 30, wherein the computational results are stored in the temporary register device during all the access time for the memory device.

34. The method recited in claim 30, further comprising the steps of:
storing the computational result in a first one of at least two series coupled temporary registers of the temporary register device during a processor clock period; and
clocking successively the computational result through the series coupled temporary registers.
